(19) United States
(12) Patent Application Publication
(10) Pub. No.: US 2014/0205062 A1
(43) Pub. Date: Jul. 24, 2014

(54) System and Method For Imaging Defects

(71) Applicants: Alan W. Hunt, Pocatello, ID (US); J. Frank Hermon, Pocatello, ID (US); Douglas P. Wells, Rapid City, SD (US)

(72) Inventors: Alan W. Hunt, Pocatello, ID (US); J. Frank Hermon, Pocatello, ID (US); Douglas P. Wells, Rapid City, SD (US)

(21) Appl. No.: 13/745,384

(22) Filed: Jan. 18, 2013

(51) Int. Cl. G01N 23/223

(52) U.S. Cl. CPC G01N 23/223
USPC 378/44; 250/309

(57) ABSTRACT

The invention is directed to a defect imaging device that has an energy beam that is directed at a device under test. The energy beam creates positrons deep within the material of the device under test. When the positrons combine with electrons in the material they produce a pair of annihilation photons. The annihilation photons are detected. The Doppler broadening of the annihilation photons is used to determine if a defect is present in the material. Three dimensional images of the device under test are created by directing the energy beam at different portions of the device under test.

### BACKGROUND OF THE INVENTION

The failure of structural and industrial materials costs the U.S. economy approximately $100 billion per year. Various non-destructive testing techniques have been employed over the years, one of them being Doppler broadening measurements using either slow positron beams or wide-energy spectrum positron beams originated from radioactive sources. However, the thickness of the samples under investigation by these methods is severely limited by the range of the impinging positrons inside the samples being tested, generally only tens of microns. In addition, the high cost and complexity of obtaining positron beams has limited the application of Doppler broadening spectroscopy techniques to basic materials science with little commercial or industrial application.

### BRIEF SUMMARY OF INVENTION

The present invention is directed to a defect imaging device that overcomes these and other problems. The defect imaging device has an energy beam that is directed at a device under test. The energy beam creates positron deep within the material of the device under test. When the positrons combine with electrons in the material they produce a pair of annihilation photons. The annihilation photons are detected. The Doppler broadening of the annihilation photons is used to determine if a defect is present in the material. Three dimensional images of the device under test are created by directing the energy beam at different portions of the device under test. As a result, the invention is able to detect defects deep inside a device under test, such as an aircraft or a bridge.

### BRIEF DESCRIPTION OF THE SEVERAL VIEWS OF THE DRAWINGS

FIG. 1 is a block diagram of a defect imaging device in accordance with one embodiment of the invention;

FIG. 2 is a flow chart of the steps used in a method of operating a defect imaging device in accordance with one embodiment of the invention;

FIG. 3 is a block diagram of a defect imaging device in accordance with one embodiment of the invention;

FIG. 4 is a block diagram of an energy beam system in accordance with one embodiment of the invention;

FIG. 5 is a block diagram of an energy beam system in accordance with one embodiment of the invention;

FIG. 6 is a block diagram of a defecting imaging system in accordance with one embodiment of the invention; and

FIG. 7 is a flow chart of the steps used in a method of imaging defects in accordance with one embodiment of the invention.

### DETAILED DESCRIPTION OF THE INVENTION

The invention enables one to analyze any material for defects deep within the material, whether a result of manufacturing defects, stress, or otherwise, and to image the defects in two and three dimensions. The invention can be applied to static or dynamic objects and materials, does not create radiation above regulatory restrictions, and is portable and highly configurable so that it can be applied in a wide variety of manufacturing environments and to virtually any object or structure, wherever it may be located. The device described herein can be used to analyze defects in objects and structures, large and small, of any construction or composition; crystal, metal, alloy, polymer, welded, bonded, cast or formed.

The invention creates positrons deep within materials with photo-nuclear methods. Several methodologies are employed to do this. The first involves the use of a bremsstrahlung beam with a maximum energy above the neutron emission thresholds to produce residual nuclei in excited states. The second involves the use of a bremsstrahlung beam with a maximum energy above the electron-positron threshold, but below the neutron emission threshold. The third method involves the use of a proton beam. The fourth method involves the use ion beams to produce residual nuclei in excited states that produce positron by their decay. The fifth method exploits cosmic rays to produce positron. These methods of producing positrons in materials are described in greater detail herein.

Using any of these methods to introduce positrons in the material, the invention images and analyzes defects in any material, of any size or thickness, at the atomic and larger levels. As described herein, the invention is referred to as the “Defect Imaging Device” and the combination of methodologies and technologies employed in its use and operation are collectively referred to as “Pair Production-Positron Annihilation Spectroscopy” or “PP-PAS”. As described in more detail below, the Defect Imaging Device employs PP-PAS to: (i) create positrons within a material to be tested through pair production or photo-activation by exposure to a bremsstrahlung (or proton-capture) gamma-beam originating from an electron or proton accelerator; (ii) recording the annihilation photons emitted from the test material during exposure by a high energy resolution detector (high resolution in energy, time or angle); (iii) record elemental specific x-ray emissions in coincidence with annihilation photons; and, (iv) imaging the pattern, spectra and correlations of annihilation photons in two or three dimensions using Doppler broadened spectra of the annihilation photons.

The principal components of the Defect Imaging Device consist of: (i) a source of positron, which may be a pulsed or continuous high energy electron accelerator of 2 MeV or above, incorporating an appropriate bremsstrahlung converter and collimators, or in the alternative, a pulsed or continuous proton accelerator; (ii) detectors of annihilation radiation and related radiations, such as one or more shielded and collimated high energy resolution detectors of the energy spectrometer and time spectrometer type; (iii) electronic circuitry properly configured to capture, process and amplify the signal created by the detection of annihilation photons, to measure correlations between various signals and to measure the Doppler broadened spectra of the annihilation photons; and, (iv) a computed tomography technology to image the results of the material analysis.

2a(i). Positron Creation; Pair Production with a High Energy Electron Accelerator, Pulsed or Continuous.

The central component of the Defect Imaging Device and the underlying PP-PAS methodologies and technologies involves the application of high-energy electron accelerator technology, either pulsed or continuous at energies of 2 MeV and above to create positrons in a test material. Electron accelerators are well-established electrical devices that deliver directed beams of electrons. For this new application, a secondary beam of photon beams is produced by electron bremsstrahlung using an appropriate heavy metal bremsstrahlung converter. The resulting photon beam (the “source energy beam”) is directed at the material to be tested. The source energy beam is collimated using one or more collimators depending upon the material to be tested so that the beam width and scan length are suitable to the test material's dimensions. In this configuration of the invention the source energy beam's maximum gamma energy is above the electron-positron pair production threshold. The source energy beam produces electron-positron pairs (“pair production”) in the test object. It is the production of positrons in the test material via these and the method described in 2c below that form the basis for the ability of the Defect Imaging Device to detect and image defects down to the atomic level in virtually any material of any size. Note that the pulsed beam option enables suppression of background by as much as 6 orders of magnitude or more, potentially allowing in situ measurements in high radiation environments, including nuclear reactors.

Another configuration of the Defect Imaging Device will also employ a continuous or pulsed laser beam, in conjunction with the Source Beams described above and in 2c below to induce and measure dynamic stress in the test material.

2a(ii). Alternative Positron Creation; Proton Accelerator, Pulsed or Continuous.

An alternative method of creating pair production within test materials is via proton-capture reactions that produce photons (gamma rays) at energies above the pair-production threshold using a pulsed or continuous proton accelerator. The proton beam irradiates a light element target such as Aluminium and produces proton capture reactions which decay producing photons with energies above the pair-production threshold. This method is similar in application to that described in 2a(i) above except that an appropriately collimated photon beam induced from a proton beam (the “source energy beam”) is directed at the test material. These photons result in pair production as they pass through the test material.

2a(iii). Alternate Positron Creation; Activation of Materials Via Nuclear Reactions.

For this new application a beam of positive ions is used to activate the material to be tested. Nuclear reactions that are exploited here include spallation nuclear reactions and neutron-knockout from incident ions. In this configuration, the source energy beam leaves the material temporarily radioactive with positron-emitting nuclei. It is the production of positrons in the test material via these and the method described in 2c below that form the basis for the ability of the Defect Imaging Device to detect and image defects down to the atomic level in virtually any material of any size.

2a(iv). Alternate Positron Creation; Cosmic-Ray Production of Positrons.

For this positron production mechanism, cosmic rays (primarily muons, but other constituents as well) cause positron-electron pair-production. This is particular advantageous in some field applications where power for an accelerator may be cost-prohibitive. It is the cosmic-ray production of positrons in the test material and the method described in 2c below that form the basis for the ability of the Defect Imaging Device to detect and image defects down to the atomic level in virtually any material of any size and in virtually any environment.

Another configuration of the Defect Imaging Device will also employ a continuous or pulsed laser beam, in conjunction with the Source Beams described above and in 2c below to induce and measure dynamic stress in the test material.

2b. Detection of Annihilation Photons and Related Radiations.

When subject to either of the source energy beams described in 2a(i-iv) above, positrons will be created within the test material via pair production. When a positron so created collides with an electron within the test material, both particles undergo annihilation, releasing radiation energy consisting of two 511 keV photons (“annihilation photons”). These annihilation photons are detected with high-energy resolution detectors, such as high purity germanium detectors, of both the energy spectrometer and time spectrometer type. These detectors are oriented to the test material and the source energy beam so as to minimize the possible detection of non-annihilation photon energy and are further shielded and collimated in a way to detect only emissions from the test material. In addition, the processes that we exploit also intrinsically produce element-specific characteristic x-rays, both from the irradiation processes and from the positron annihilation event. The measurement of these x-rays in coincidence with 511 keV photons enables elemental identification of the location of the annihilation events, and it enables ‘doping’ studies, whereby dopants are strategically added to manufacturing processes to allow better spatial and elemental understanding of flaws in the production process.

2b(i). Measurement and Analysis of Annihilation Photons; Doppler Broadening.

As the photon produced positrons travel within the test material they annihilate with electrons within the material producing two 511 keV annihilation photons. Because the distribution of electrons is very nearly uniform throughout a material, the production of annihilation photons will likewise be uniform throughout the material. However, a characteristic of “defect points” within any given material (at both the atomic and larger level) is that electrons in and about defect points will have low momentum vis-à-vis electrons in those portions of the material without defects. These defects include mono-vacancies, di-vacancies and larger open volume defects in the material. The annihilation of positrons with high momentum electrons in a test material as compared to low momentum electrons in the same test material results in Doppler broadening. Consequently, the annihilation of a positron in material containing one of these low momentum electrons (i.e. a defect) as compared to the annihilation of a positron with the high momentum electrons in the material (i.e. a non-defect) can be analyzed and imaged using the Doppler broadening techniques described herein. Thusly, the defect point(s) in the material are identified and imaged using the techniques described herein.

2b(ii). Measurement and Analysis of Annihilation Photons; Timeframe.

The time period during which annihilation photons are produced and the rate of decay in production can be measured using the techniques described above and provide an important diagnostic tool respecting the nature of the material and any defects. In particular, the larger the defect the longer that the positron “lives” because the presence of defects means the absence of atoms and their associated electrons. Less electrons means less probability of a positron-electron collision and, therefore, a longer lifetime.

2b(iii). Measurement and Analysis of Annihilation Photons; Angular Correlation.

The angle at which each two annihilation photons are emitted during the process of positron annihilation can be measured using the techniques described above and provide another important diagnostic tool respecting the nature of the material and any defects. When a positron annihilates with a high-momentum electron, there is a significant Doppler angular shift (away from 180 degrees), just like there is a significant Doppler energy shift (from 511 keV). In the presence of defects, the frequency of collisions with high-momentum electrons goes down, and the angular Doppler broadening decreases.

2b(iv) Measurement of Characteristic X-Rays in Coincidence with Annihilation Photons.

The x-ray photon produced subsequent to the annihilation process is detected with x-ray spectroscopic detectors. When these x-rays are detected in coincidence with annihilation radiation, site-specific and element-specific information about defects is obtained. This technique can be used in conjunction with ‘doping’ of impurities in manufacturing processes, particularly in composites, to trace the origin of material failures and manufacturing process flaws.

2c. Imaging of Annihilation Photons.

The detection of the annihilation photons by the detectors described in 2c above creates a signal that is amplified and processed using novel electronic circuitry. The signals so processed (including one or all of the Doppler broadening, timeframe, and angular correlation methodologies described in 2b and 2c above) are then analyzed using novel computed tomography techniques to create an image of any defects in the material. This imaging includes incorporation of coincident x-ray signals into the electronic processing and data stream.

2d. Configuration of the Defect Imaging Device.

The Defect Imaging Device described herein will employ the methodologies and technologies described herein to image defects occurring in materials in two and three dimensions. The application of the invention requires that the object to be tested be scanned by the source beam. While numerous configurations of the device will be employed depending upon the objects to be tested (for example, steel railroad rails versus small automotive parts) the configurations will be one of two general types.

The first general type is a Defect Imaging Device that is more or less stationary and in which the object to be tested is placed (or through which it passes) in order to be tested. In this configuration the object scanned is moved through the source beam in two or three dimensions using an appropriate combination of mechanical and beam orientation techniques so as the test site on the object is subjected to the source beam. The detectors are located in a fixed position with respect to the source beam and test object so as to maximize the capture of annihilation photons from the test object.

The second general type is a Defect Imaging Device that is mobile or portable and which is placed in the proper location with respect to, or moved around and about, the object to be tested. In this configuration, the object scanned remains more or less stationary. The source beam of the Defect Imaging Device scans the object in two or three dimensions using an appropriate combination of mechanical and beam orientation techniques so that the test site on the object is subjected to the source beam. The detectors are located in a fixed position with respect to the source beam and move about the test object in relation to the source beam. In some embodiments of this configuration, the source beam is cosmic rays.

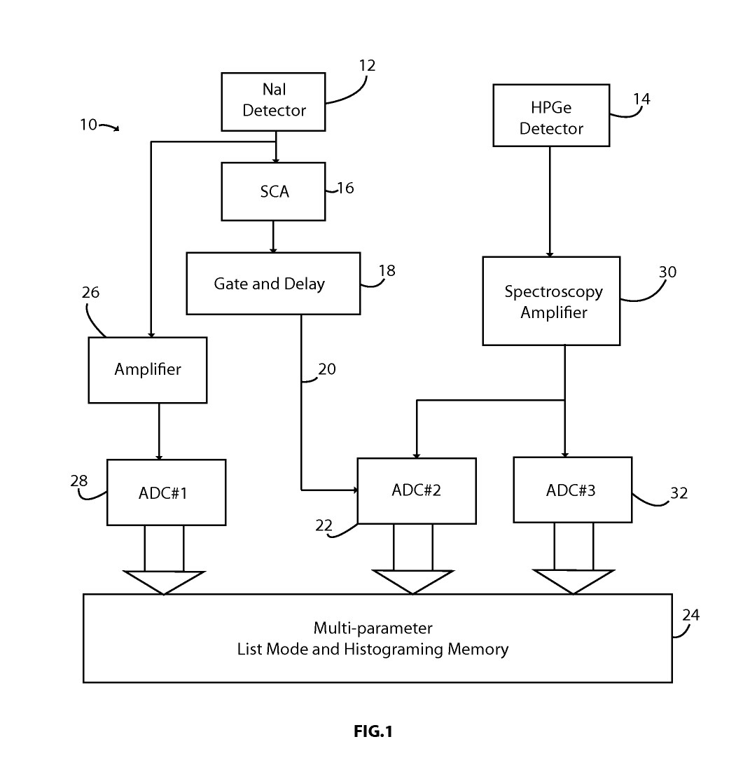

FIG. 1 is a block diagram of the electronics used to image defects using positron annihilation spectroscopy. The system 10 has a sodium iodine (NaI) detector 12 and a high purity germanium (HPGe) detector 14. The sodium iodine (NaI) detector 12 is connected to a single channel analyzer 16. The single channel analyzer 16 determines if a signal is above a certain threshold. The output of the single channel analyzer 16 is coupled to a gate and delay electronics block 18. The gate and delay block 18 has a gate signal 20 that gates a data acquisition counter 22. The output of the data acquisition counter 22 is coupled to a computer 24 that runs a multi-parameter list mode and histogram program.

The sodium iodine (NaI) detector 12 is also coupled to an amplifier 26. The amplifier 26 is coupled to another data acquisition counter 28. The output of the data acquisition counter 28 is coupled to a computer 24 that runs a multi-parameter list mode and histogram program.

The high purity germanium (HPGe) detector 14 is coupled to a spectroscopy amplifier 30. The spectroscopy amplifier 30 is a highly linear amplifier that preserves the pulse shape from the high purity germanium (HPGe) detector 14. The output of the spectroscopy amplifier 30 is split into two parts. One part is coupled to the data acquisition counter 22 and the second part is coupled to another data acquisition counter 32.

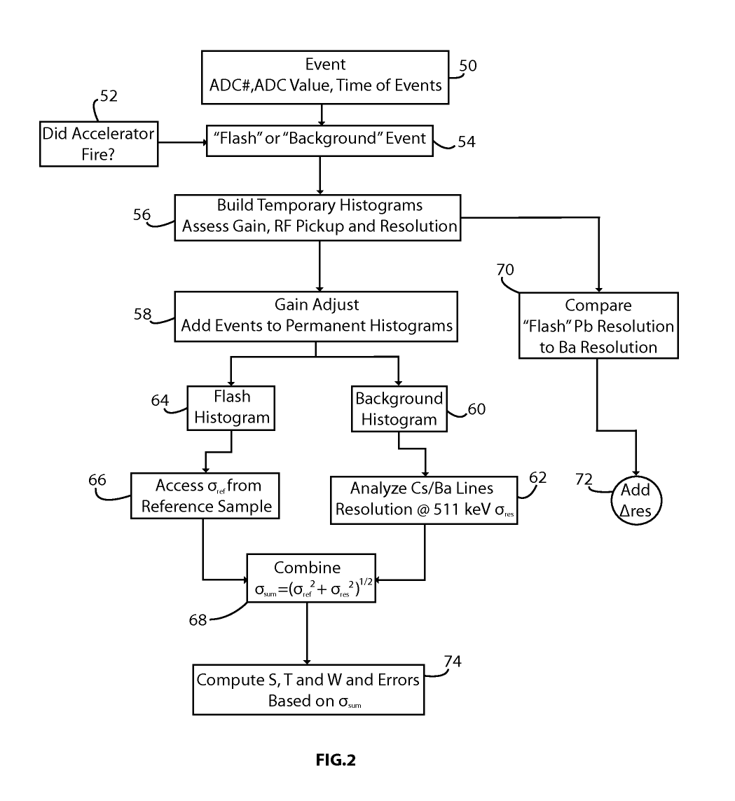

FIG. 2 is a flow chart of the steps used to process the data gathered by the electronics in FIG. 1. The process starts, by logging an event data at step 50. The parameters collected include the data acquisition counter number (i.e., whether the data comes form ADC 22, 28 or 32), the ADC value or maximum amplitude and the time of the event. At step 52, it is determined if the accelerator fired. Based on this information, an event is determined to be either a flash or a background event at step 54. These steps 50, 52 & 54 are repeated for multiple events and the information is used to build temporary histograms at step 56. These histograms are used to assess the gain from the electronics and adjust the output for a standard gain profile. In addition the histograms are used to determine if there is any RF noise in the data and adjust the resolution accordingly. The gain adjustment starts by adding the temporary histograms to permanent histograms at step 58. Next, the process splits for background events and flash events (test data). If the histogram is a background event at step 60, then the cesium (Cs) and barium (Ba) lines in the histogram are analyzed and the resolution of the annihilation photons (511 keV) is adjusted accordingly at step 62. When the histogram is a flash histogram at step 64 the spreading of a reference sample is determined at step 66. The total energy spreading that can be expected is determined at step 68 and this information is used to determine if an event(s) shows a defect.

In order to determine if any RF noise is present in the data the resolution (energy spreading) of the lead lines are compared to the resolution of the barium lines at step 70. When there is a difference in the amount of spreading in these two groups of lines it is due to RF noise and this is added to the background information at step 72.

Once the histograms have been adjusted for spreading the S, T and W and Errors are computed at step 74 and the determination of material defects is made. The S parameter is the “Shape” parameter and reflects the annihilation with low momentum valence and unbound electrons and is defined as the ratio of the counts in the central region of the peak to the counts in the peak. The W parameter for “Wings” reflects the annihilation with high momentum core electrons and is defined as the ratio of counts in the wing regions of the peak to the total counts in the peak. A high concentration of defects, or an increase in the means size of defects, leads to a larger contribution of annihilation photons from low momentum electrons because positrons are trapped at defects. This is reflected in Doppler broadening measurements by an increase in S parameter and a decrease in W parameter. The T parameter is W/S as the T parameter increase it means there are fewer defects and as the T parameter decreases it means there are more defects.

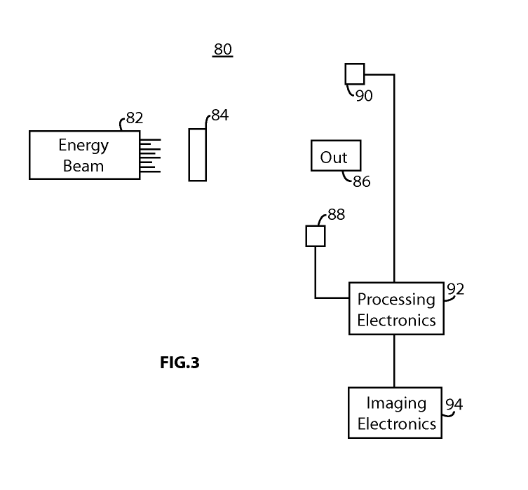

FIG. 3 is a block diagram of a defect imaging device 80 in accordance with one embodiment of the invention. The device 80 has an energy beam 82 that has an output that passes through a collimator 84. The beam is then directed to a device under test 86. The annihilation photons are detected by detectors 88, 90. Processing electronics 92, such as that shown in FIG. 1, then determines the location of defects in the device under test 86. Imaging electronics 94 then combines a number of slices of the device under test 86 to form a two or three dimensional image of the defects in the device under test 86.

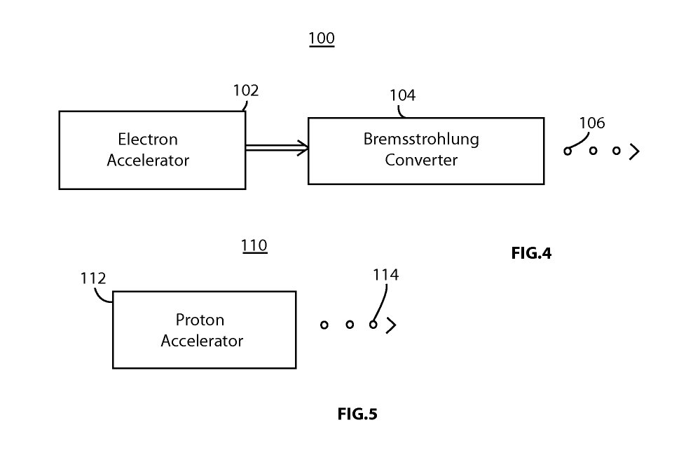

FIG. 4 is a block diagram of an energy beam system 100 in accordance with one embodiment of the invention. The energy beam system 100 has a electron accelerator 102 with an output 104 directed at a bremsstrahlung converter 104. The bremsstrahlung converter 104 converts the input electrons into gamma rays 106.

FIG. 5 is a block diagram of an energy beam system 110 in accordance with one embodiment of the invention, that uses a proton accelerator 112. The protons 114 are directed at the device under test.

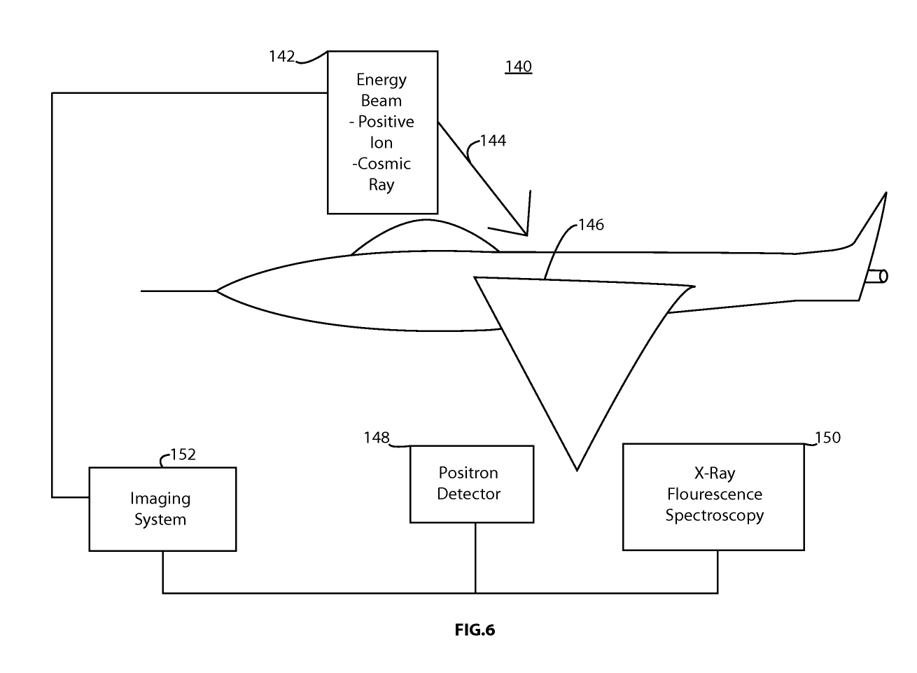

FIG. 6 is a block diagram of a defecting imaging system 140 in accordance with one embodiment of the invention. The system 140 includes an energy beam 142 that may be a positive ion beam or cosmic rays. The output 144 of the energy beam 142 is directed to a device under test 146, which in this case is an aircraft wing. The energy beam creates positron inside the device under test 146. When these positron undergo annihilation with an electron they form a pair of positron photons. The positron annihilation photons are detected by a positron detector 148. The energy beam 144 also creates coincident x-rays, which are detected by an x-ray fluorescence spectroscopy system 150. The positron detector 148 and x-ray fluorescence spectroscopy system 150 are connected to an imaging system 152. The imaging system 152 images the pattern, spectra and correlations of annihilation photons in two or three dimensions using Doppler broadened spectra of the annihilation photons. In one embodiment, the defect imaging device may be used in the field with little power. This is accomplished by using cosmic rays as the energy beam to produce positrons. The excitation of the x ray signal occurs when the annihilation occurs. This latter signal can be used to pick out particular annihilation signals by using standard electronic coincidence techniques. This scheme also does not require collation or shielding of the cosmic rays as the electronics arrangement identifies the annihilation site. In one embodiment, the aircraft wing is made of a composite material. The composite material is doped with a high atomic number element to enhance the production of positrons. Composite materials composed of two or more separate components with high-strength fibers of glass, boron, plastic or carbon that are embedded in an epoxy resin matrix do not readily produce positron pairs due to the low atomic number (Z) of the chemical components. Positron production is proportional to Z². The addition of a high Z doping material, suitable for chemical incorporation into the epoxy resin or laminating bonding agents with loading at the parts-per million to parts-per billion (ppm-ppb) concentration, will provide suitable positron production and annihilation sites enhancing PAES detection signals for inspection of stress and delaminating defects using accelerators. Most secondary cosmic rays reaching the Earth's surface are muons, with an average intensity of about 100 per m² per second.

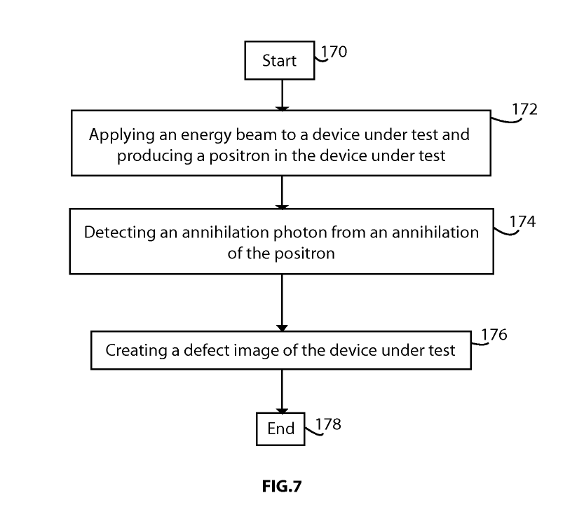

FIG. 7 is a flow chart of the steps used in a method of imaging defects in accordance with one embodiment of the invention. The process starts, step 170, by applying an energy beam to a device under test and producing positrons in the device under test at step 172. An annihilation photon from the annihilation of a positron is detected at step 714. At step 176, a defect image of the device under test is created, which ends the process at step 178.

In one embodiment, the energy beam is a beam of ions. The device under test may be doped with a high atomic number element.

Thus there has been describe a device for nondestructive defect analysis of virtually any material, including crystals, metals, alloys, and polymers. The method employed allows one to study defects in thick samples; up to meters in some materials. These are depths of study unavailable by any other known method of nondestructive analysis. The methods employed are commercially economical, can be performed on materials in-situ without removal to a specialized laboratory, can be performed on operating systems (for example, the turbine blades of an operating jet engine), on thick structures, and at radiation levels within regulatory requirements. This invention is the only method for nondestructive testing that is penetrating, portable, and that can reliably detect and image defects in thick structural and/or operating materials.

While the invention has been described in conjunction with specific embodiments thereof, it is evident that many alterations, modifications, and variations will be apparent to those skilled in the art in light of the foregoing description. Accordingly, it is intended to embrace all such alterations, modifications, and variations in the appended claims.

What is claimed is:

1. A system for imaging defects, comprising:
a composite material of a device under test doped with a high atomic number element;
an energy beam directed at the device under test and producing a positron in the device under test; and
a detection system receiving an annihilation photon from the annihilation of the positron.

2. The system of claim 1, wherein the energy beam is a cosmic ray.

3. The system of claim 1, further including an x-ray detector receiving an x-ray emitted from the device under test.

4. The system of claim 3, wherein the x-ray detector is an x-ray fluorescence spectroscopy system.

5. The system of claim 1, wherein the energy beam is a beam of positive ions.

6. The system of claim 2, further including an x-ray fluorescence spectroscopy system analyzing an x-ray emitted from the device under test.

7. The system of claim 1, wherein the detection system includes a high purity germanium detector.

8. A defect imaging device, comprising:
an cosmic ray energy beam directed at a device under test;
an x-ray fluorescence spectroscopy system analyzing an x-ray emitted from the device under test; and
an imaging device receiving an output from the x-ray fluorescence spectroscopy system.

9. The device of claim 8, further including a positron detection system receiving an annihilation photon from the annihilation of a positron produced in the device under test from the cosmic ray energy beam

10. The device of claim 9, wherein the device under test is doped with a high atomic number element.

11. The device of claim 10, wherein the dopping is less than one part per million.

12. The device of claim 9, wherein the positron detection system includes a high purity germanium detector.

13. A method of detecting defects in a device under test, comprising the steps of:
applying an energy beam to a device under test and producing a positron in the device under test;
detecting an annihilation photon from an annihilation of the positron; and
creating a defect image of the device under test.

14. The method of claim 13, wherein the step of applying the energy beam includes the step creating a beam of positive ions.

15. The method of claim 13, further including the step of doping the device under test with a high atomic number element.

16. The method of claim 13, further including the step of detecting an x-ray emitted from the device under test.

17. The method of claim 13, wherein the step of applying the energy beam includes the step of subjecting the device under test to a cosmic ray.
